(19) United States
(12) Patent Application Publication
(10) Pub. No.: US 2018/0314804 A1
(43) Pub. Date: Nov. 1, 2018

(54) SYSTEM AND METHOD FOR MANAGING DIGITAL FOOD INFORMATION

(71) Applicant: Kafoodle Limited, London (GB)

(72) Inventors: Tarryn Gorre, London (GB); Kim Antoniou, London (GB)

(21) Appl. No.: 15/499,961

(22) Filed: Apr. 28, 2017

(51) Int. Cl. G06F 19/00; G06Q 50/12; G09B 19/00

(52) U.S. Cl. CPC G06F 19/3475; G09B 19/0092; G06Q 50/12

(57) ABSTRACT

A system for managing digital food information. The system includes a data processing arrangement coupled to a plurality of computing device associated with food service providers and a plurality of computing devices associated with consumers, via a communication network. Furthermore, the data processing arrangement is operable to generate digital food plans including at least one food item. The at least one food item is defined with food information including at least one of ingredients and cooking procedure associated with the at least one food item. Additionally, the data processing arrangement is operable to receive consumer information, provided by the consumer, including food habit, food preferences, nutritional requirements, medical conditions, use of medications, general physical condition, age, allergies and undesirable food ingredients. The data processing arrangement is further operable to filter the digital food plans, based on the consumer information, to provide desirable food items to the consumers.

### TECHNICAL FIELD

The present disclosure relates to systems for managing digital food information. The present disclosure also relates to methods of managing the digital food information. Moreover, the present disclosure relates to a software product recording on machine-readable data storage media that is executable upon computing hardware for implementing the aforesaid methods.

### BACKGROUND

With growing awareness about importance of diet, and increasing number of diet-dependent health conditions there has been an increase in consciousness among many consumers regarding certain ingredients that may be harmful, or beneficial, to their health. Moreover, it is common practice for many consumers to check a restaurant menu to spot items that meet their dietary preferences. Furthermore, consumers with food allergies and other medical conditions have strict food preferences, which make selection of restaurants and food items difficult. Moreover, not only restaurants but also other food service providers, such as care homes, nurse homes, hospitals and so forth, struggle to personalise their residents' and patients' food plan.

Also, the selection of food is not based on all personal nutritional and dietary requirements such as general physical condition, age, allergies, medical condition, prescribed medication, allergies and personal preferences. Also, the consumers are often not aware of the effects that the consumption of certain products may have on their health based on effectiveness of their prescribed medication.

Conventionally, the food service provider's staff (such as waiters, nurses, carers and so forth) perform task of providing consumers with information related to food items served by them. However, at times they are not apprised of all the ingredients used for preparing the food items, and therefore may not communicate appropriate and sufficient information when asked by the consumers. In such instance, consumer suffering from a food allergy, certain medical conditions or having strong food preferences may be served with a food item having an ingredient that can cause harm to their health or wellbeing. In one example, this can lead to adverse reactions and/or extreme situations, such as anaphylactic shock.

Moreover, with the advent of internet technologies in the catering industry, consumers tend to check for restaurant and their menu items online. However, many ingredients have different names and/or can be found as sub-ingredients in various main ingredients. Furthermore, different restaurants may prefer to identify/name their menu items differently. Therefore, in such scenarios, a consumer may have difficulty, or in certain cases be unable to identify the menu items that might be harmful (for example allergic) to the consumer and to personalise their diet in a manner that conforms to their dietary and medical requirements.

Additionally, a mismatch between the amount of food ordered and consumed may cause a huge food waste problem. For example, in developed countries food, about 100 kilograms per person per year is wasted at the consumption stage, and that is mainly due to a mismatch between the amount of food ordered and consumed.

Therefore, in light of the foregoing discussion, there exist problems associated with providing required food information to the consumers.

### SUMMARY

The present disclosure seeks to provide improved systems for managing digital food information, for example, a system for managing digital food information that is operable to provide optimized digital food information to a consumer.

Moreover, the present disclosure seeks to provide an improved method of managing digital food information for providing optimized digital food information to a consumer.

According to a first aspect, there is provided a system for managing digital food information, the system includes a data processing arrangement, a plurality of computing devices associated with food service providers, a plurality of computing devices associated with consumers, wherein the data processing arrangement is coupled via a communication network to the computing devices of the food service providers and the consumers, characterized in that the data processing arrangement is operable to:

generate a digital food plan, by each of the plurality of food service providers using the computing devices associated therewith, comprising at least one food item, wherein the at least one food item is defined with food information including at least one of ingredients and cooking procedure associated with the at least one food item;

receive consumer information including at least one of: food habit, food preferences, nutritional requirements, medical conditions, use of medications, general physical condition, age, allergies and undesirable food ingredients, to be provided by the consumer using the computing devices associated with the consumers; and

filter the digital food plans, based on the consumer information, to provide desirable food items to the consumers.

The present disclosure seeks to provide an efficient system for managing digital food information, which is operable to filter digital food plans generated by the food service provider, based on preferred consumer information, further the system is operable to suggest desirable food items for the consumers based on the consumer information.

According to a second aspect, there is provided a method for managing digital food information, characterized in that the method includes:

generating a digital food plan comprising at least one food item, wherein the at least one food item is defined with food information including at least one of ingredients and cooking procedure associated with the at least one food item;

receiving consumer information including at least one of: food habit, food preferences, nutritional requirements, medical conditions, use of medications, general physical condition, age, allergies and undesirable food ingredients, to be provided by consumers; and

filtering digital food plans, based on the consumer information, to provide desirable food items to the consumers.

According to a third aspect, there is provided a software product recording on machine-readable data storage media, characterized in that the software product is executable upon computing hardware for implementing the aforesaid method for managing digital food information.

According to a fourth aspect, there is provided a system for managing digital food information, the system includes at least one device associated with a food service provider, the at least one device includes a data processing arrangement, characterized in that the data processing arrangement is operable to:

generate a digital food plan, by the food service provider using the computing device associated therewith, comprising at least one food item, wherein the at least one food item is defined with food information including at least one of ingredients and cooking procedure associated with the at least one food item;

receive consumer information including at least one of: food habit, food preferences, nutritional requirements, medical conditions, use of medications, general physical condition, age, allergies and undesirable food ingredients; and

filter digital food plans, based on the consumer information, to provide desirable food items to consumers.

It will be appreciated that features of the invention are susceptible to being combined in various combinations without departing from the scope of the invention as defined by the appended claims.

### DESCRIPTION OF THE DIAGRAMS

Embodiments of the present disclosure will now be described, by way of example only, with reference to the following diagrams wherein:

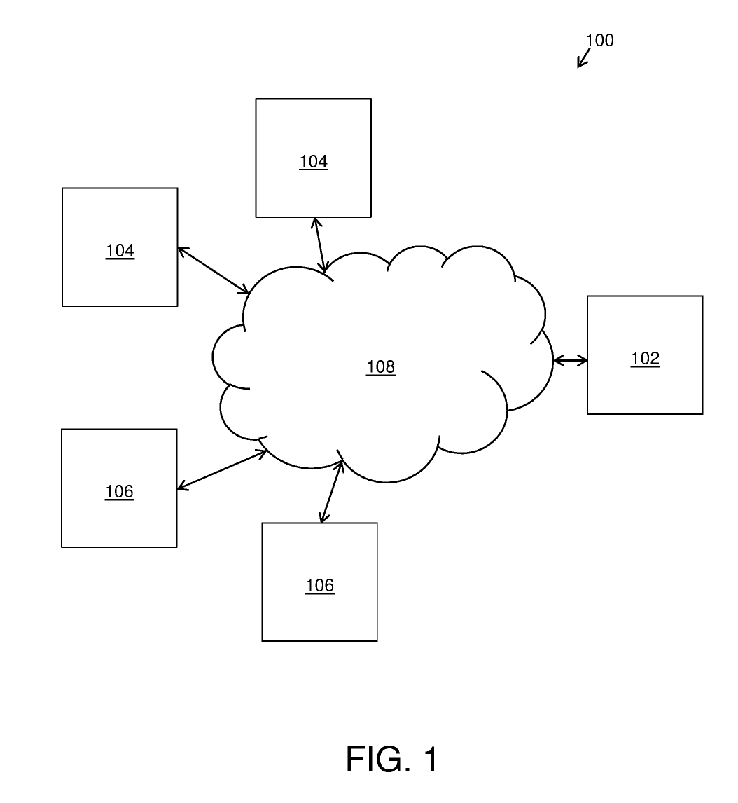

FIG. 1 is a block diagram of an architecture of a system for managing digital food information, in accordance with an embodiment of the present disclosure;

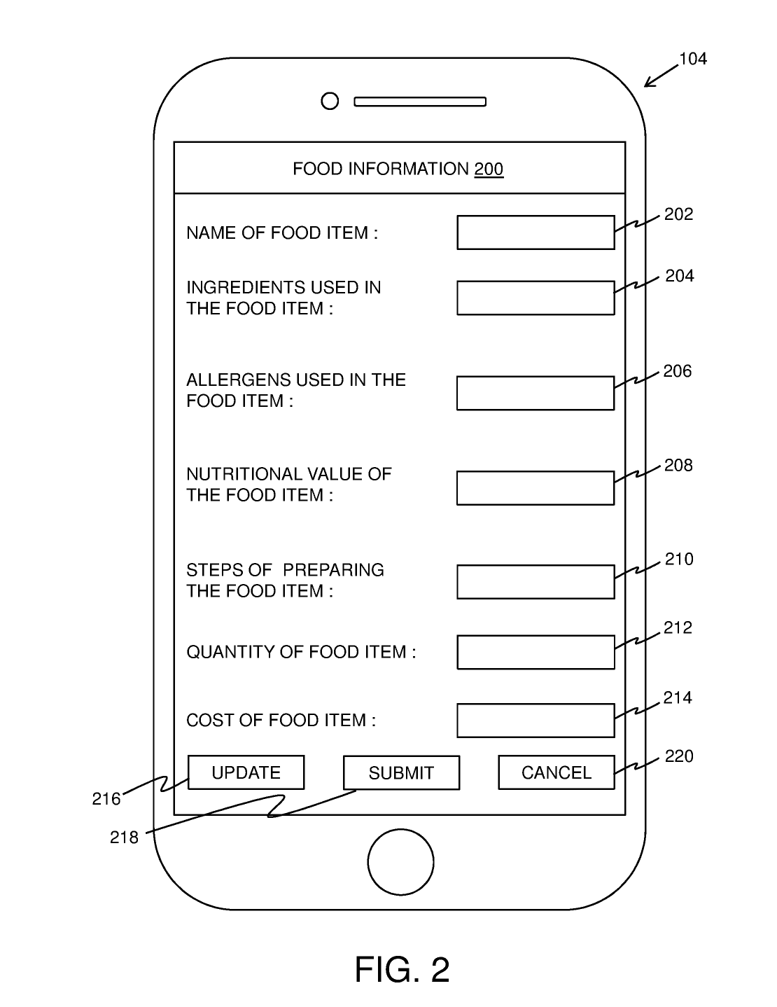

FIG. 2 is a schematic illustration a computing device, of the system of FIG. 1, associated with a food service provider having an exemplary user interface, in accordance with an embodiment of the present disclosure;

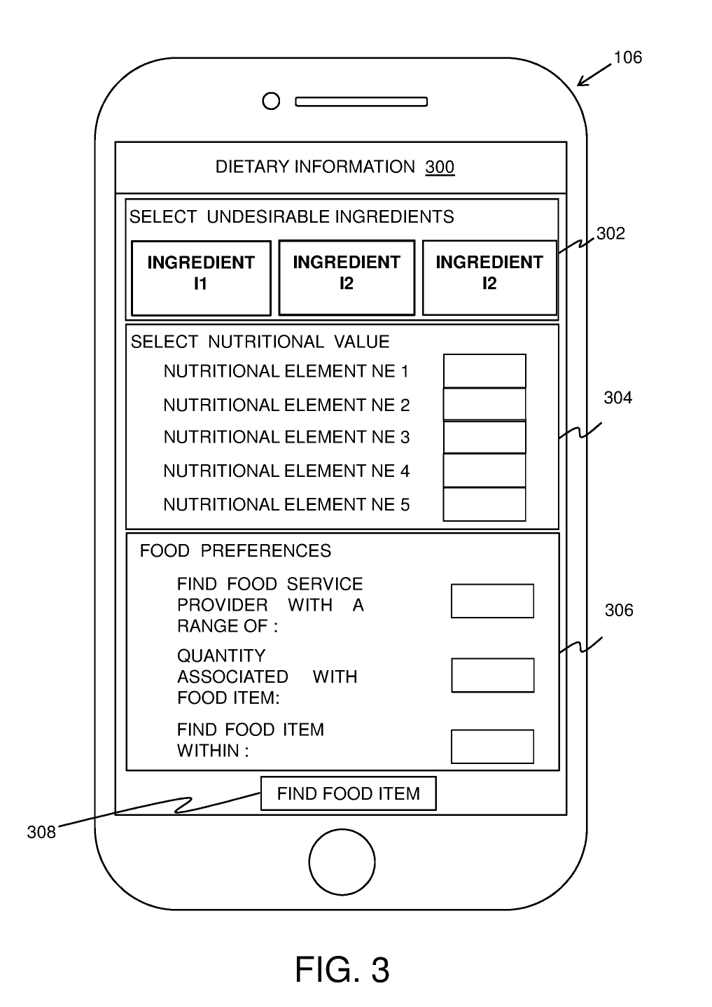

FIG. 3 is a schematic illustration a computing device, of the system of FIG. 1, associated with a consumer having an exemplary user interface, in accordance with an embodiment of the present disclosure; and

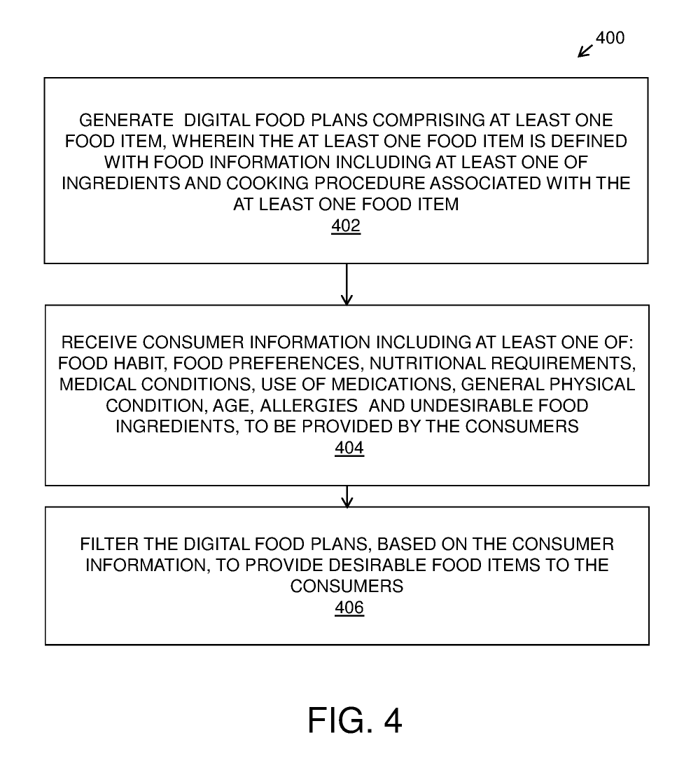

FIG. 4 is an illustration of steps of a method of managing digital food information, in accordance with an embodiment of the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, embodiments of the present disclosure are concerned with a system for managing digital food information that is operable to provide enhanced human-computer interactability, simplify the food service provider locating process, provide an increased safety for the consumers and fulfill the consumer's food consumption needs.

Referring to FIG. 1, illustrated is a block diagram of an architecture of a system 100 for managing digital food information, in accordance with an embodiment of the present disclosure. As shown the system 100 includes a data processing arrangement 102, a plurality of computing device 104 associated with food service providers, a plurality of computing devices 106 associated with consumers, wherein the data processing arrangement 102 is coupled via a communication network 108, to the computing devices 104 and 106, of the food service providers and the consumers.

Optionally, the term ‘digital food information’ as used herein relates to an organized and structured representation of metadata related to food in a computer-implemented environment. Specifically, the metadata includes both non-commercial and/or commercial data related to food. Optionally, the non-commercial data related to food includes description of food, service providers that provide food, ingredients and allergens used in food, medical data associated with the ingredients and allergens used in food, calorific value of the ingredients and allergens used in the food, method of preparation of the food, quantity of the food in one serving, environment of preparation of the food, and so forth. Furthermore, the commercial data related to food includes the cost of the ingredients and allergens used in food, the cost of a recipe per serving, sampling cost of a recipe per serving, additional charges associated with per serving of a recipe, profit of a recipe per serving, and so forth. Furthermore, the metadata related to food is stored and processed in a data processing arrangement (such as the data processing arrangement 102 of the system 100) to generate, process and manage the digital food information.

Optionally, the term ‘data processing arrangement’ as used herein relates to an arrangement including programmable and/or non-programmable components that are configured to manage the digital food information. Optionally, the data processing arrangement 102 is implemented using one or more database servers. Specifically, the database servers may be hardware, software, firmware or a combination of these, suitable for storing and processing the digital food information. Optionally, the database servers may include functional components, for example, a processor, a memory, a network adapter and so forth. Additionally, the database servers provide a computing platform wherein a plurality of computer programs may be installed for managing digital food information. In operation, the database servers of the data processing arrangement 102 may include various modules for storing and processing information, such as the digital food information.

Optionally, the data processing arrangement 102 is operable to store and process information provided by the food service providers and the consumers via the computing devices, such as the computing devices 104 associated with the food service providers and the computing devices 106 associated with the consumers.

Optionally, the term ‘computing device’ as used herein relates to an electronic device associated with (or used by) a user, such as the food service providers and/or the consumers. Specifically, the computing devices 104, 106 associated with the food service providers and the consumers, respectively, include hardware, software, firmware, or a combination of these. Furthermore, the computing devices 104, 106 relate to portable computing devices and/or fixed computing devices. Examples of the computing devices 104, 106 include but are not limited to, desktop computers, laptop computers, tablet computers, phablet computers, smartphones, and personal digital assistants.

Optionally, the computing devices 104, 106 are operable to render user interfaces (such as the exemplary user interface 200, 300 of FIG. 2 and FIG. 3 respectively) thereon, to facilitate interaction between the food service provider and/or the consumer, and the data processing arrangement 102. Furthermore, the user interface may include icons, on-screen keyboards, pull-down menus, buttons, control options, and audio-visual indicators to receive input from the at least one user. Additionally, the user interface is used to provide text input, voice input, keypad input, image input, image capture, and so forth. For example, the user interface may be used by a food service provider to input metadata related to food in the form of text messages via a keypad input. In such example, the keypad input may be provided via a virtual keyboard and/or a physical keyboard. Further, the user interface may consequently interact with the food service provider and/or the consumer by employing text output, voice output, image output, and so forth. Alternatively, optionally, the food service provider and/or the consumer is associated with one or more computing devices. For example, a single user may be associated with three computing devices, namely, a desktop computer, a tablet computer, and a smartphone.

Optionally, the computing devices 104, 106 are configured to execute a user agent application thereon, to communicate with the data processing arrangement 102. Specifically, the user interfaces rendered on the computing devices 104, 106 are operable to facilitate interaction between the food service provider and/or the consumer, and the data processing arrangement 102, upon execution of the user agent application. Furthermore, the user agent application establishes communication between the computing devices 104, 106 and the data processing arrangement 102, through the communication network 108.

Optionally, the term ‘communication network’ as used herein relates to an arrangement of interconnected programmable and/or non-programmable components that are configured to facilitate connection between the data processing arrangement 102, the computing devices 104, 106. Furthermore, the communication network may be an individual network, or a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

Optionally, the system 100 may be implemented in cloud computing environments where tasks are performed by remote processing devices (such as the data processing arrangement 102) that are linked through a communications network (such as the communications network 108) to the computing nodes (such as the computing devices 104, 106).

Referring to FIG. 2, illustrated is a schematic illustration the computing device 104, of the system 100 of FIG. 1, associated with a food service provider having an exemplary user interface 200, in accordance with an embodiment of the present disclosure. As shown, FIG. 2 includes input fields (such as the input fields 202 to 212) for providing food information related to at least one food item. Furthermore, the food information provided by the food service provider via the exemplary user interface 200 is provided to the data processing arrangement 102 (shown in FIG. 1) via the communication network 108, and stored therein.

The data processing arrangement 102 is configured to generate a digital food plan, by each of the plurality of food service providers using the computing devices 104 associated therewith, comprising at least one food item. The at least one food item is defined by the food information provided by the food service provider using the computing device 104 associated with the food service provider, and wherein the food information includes ingredients and allergens associated with the at least one food item.

Optionally, the term ‘food service provider’ as used herein relates to organizations, and/or individuals operable to prepare and supply food item for consumers. For example, the food service provider may be a restaurant and/or a catering service including a plurality of individuals associated to the restaurant and/or a catering service, such as chefs, line cooks, prep cooks, apprentices, nutritionist, dietician and so forth. Additionally, the food service provider may be organizations, and/or individuals that are associated with domiciliary care, care homes or hospitals. Furthermore, the food service provides may be operable to provide food to the consumers residing within domiciliary care, care homes or hospitals. Optionally, the food service provider uses the exemplary user interface 200 of the computing device 104 to input the food information for defining the at least one food item, and thereby generating the digital food plan comprising the at least one food item.

Optionally, the term ‘digital food plan’ (or a digital meal plan or a digital food menu) as used herein relates to digital display of a list comprising at least one food item that is prepared and supplied by the food service provider to the consumer. Specifically, a digital food plan is an electronic list of food items that is created by the food service provider in the computing device 104. Furthermore, the food service provider creates the digital food plan by inputting food information via the input fields 202 to 220 displayed in the exemplary user interface 200, for defining the at least one food item. Alternatively, optionally, the food service provider may input information related to more than one food item, thereby creating a plurality of food items in the digital food plan.

Optionally, the exemplary user interface 200 is configured to acquire data associated with the food items offered by the service providers to the consumers. Specifically, the input fields 202 to 220 displayed in the exemplary user interface 200 are configured to accept the food information, such as the digital food information provided by the food service provider. In an example, the food service provider may use input field such as the input field 202 in the exemplary user interface 200, displayed on the computing device 104 for inputting a name of the food item. In such example, a food service provider ‘ABC’ may name a food item as ‘Chefs Special’. In another example, the food service provider may use input field such as the input field 204 to input the names of the ingredient used in the recipe of a food item such as the food item ‘Chefs Special’. In such example, the food item ‘Chefs Special’ may include the ingredients ‘I1’, ‘I2’, ‘I3’, ‘I4’, ‘I5’, ‘I6’, and ‘I7’.

In another example, the food service provider may use input field such as the input field 206 to input the names of the allergen used in recipe of a food item such as the food item ‘Chefs Special’. In such example, the food item ‘Chefs Special’ may include the allergens ‘A1’, ‘A2’, and ‘A3’. It is to be understood that the food service provider may also provide alternative names for the ingredients and the allergens. This will allow in exhaustively covering the details for the ingredients and the allergens used in preparation of a food item. In another example, the food service provider may use input field such as the input field 208 to input the amount of nutritional value associated to a food item such as the food item ‘Chefs Special’. In such example, the food item ‘Chefs Special’ may have a nutritional value of 106 kilo caloric (kcal) per serving.

Optionally, in another example, the exemplary user interface 200 may be operable to provide input fields (not shown) for the food service provider to manually input the amount of nutritional value for each of the ingredient and/or the allergens used in the recipe of the food item ‘Chefs Special’, based on the quantity of ingredient and/or the allergens used. Furthermore, in another example, the exemplary user interface 200 may be operable to automatically generate individual nutritional value for each of the ingredient and/or the allergens used in the recipe of the food item ‘Chefs Special’, based on the quantity of ingredient and/or the allergens used. Moreover, the exemplary user interface 200 may be operable to automatically generate a total nutritional value for the amount of food served in one serving of the food item ‘Chefs Special’.

In another example, the food service provider may use input field, such as the input field 210, to provide steps for preparing the food item such as the food item ‘Chefs Special’. In such example, the food service provider may list down the exact steps of preparing the food item ‘Chefs Special’. Furthermore, the food service provider may provide a video showing the steps for preparing the food item ‘Chefs Special’. In another example, the food service provider may use input field such as the input field 212 to input the amount of cost associated with a food item such as the food item ‘Chefs Special’. In such example, the food item ‘Chefs Special’ may have a cost of ‘100 dollars’ per serving.

In another example, the food service provider may use input field, such as the input field 212, to provide the quantity of food item that may be provided in one serving of the food item. In such example, the food service provider may manually input the quantity of food that may be provided in one serving of the food item, such as the food item ‘Chefs Special’. Optionally, in another example, the exemplary user interface 200 may be operable to automatically generate the quantity of food based on the amount of ingredient and the allergen used for the food item ‘Chefs Special’.

In another example, the food service provider may use input field, such as the input field 214, to provide the cost of food item that may be provided in one serving of the food item. Optionally, in another example, the exemplary user interface 200 may be operable to provide input field 214 for the food service provider to manually input the cost of the food item, such as the food item ‘Chefs Special’. Optionally, in another example, the exemplary user interface 200 may be operable to provide input fields for the food service provider to manually input the cost of each of the ingredient and/or the allergens used in the recipe of the food item ‘Chefs Special’, based on the quantity of ingredient and/or the allergens used. Furthermore, in another example, the exemplary user interface 200 may be operable to automatically generate individual cost for each of the ingredient and/or the allergens used in the recipe of the food item ‘Chefs Special’, based on the quantity of ingredient and/or the allergens used. Moreover, the exemplary user interface 200 may be operable to automatically generate a total cost of food item ‘Chefs Special’ served in one serving, based on the amount of ingredients and/or the allergens used in the recipe.

Optionally, the exemplary user interface 200 may provide a selection button, such as the button 216 for a food service provider to edit and/or update the food information related to the food item. Specifically, the food service provider may edit and/or update the food information related to the food item, in order to reflect a change in the food item. For example, in an event wherein an ingredient ‘I1’ and allergen ‘A1’ used in the recipe of the food item ‘FI1’ has been altered to ingredient ‘I2’ and allergen ‘A2’, the food service provider may select the button 216 of the exemplary user interface 200 to update the information of the food item ‘FI1’ for displaying that the recipe of the food item ‘FI1’ include the ingredient ‘I2’ and allergen ‘A2’. In another example, the exemplary user interface 200 may include selection button, such as the button 218. In such example, the service provider may select the button 218 to save the inputted food information for a food item such as the food item ‘Chefs Special’. In another example, the exemplary user interface 200 may include selection button, such as the button 220. In such example, the service provider may select the button 220 to discard the inputted food information for a food item such as the food item ‘Chefs Special’. This allows the food service providers to easily perform and reflect changes made to a food item of a digital food plan using the computing device 104.

Additionally, the food information inputted by the food service provider in the input fields 202 to 212 displayed in the exemplary user interface 200 is provided to the data processing arrangement 102 for storing and processing. Furthermore, the data processing arrangement 102 is operable to generate the digital food plan based the food information provided by the food service provider in the exemplary user interface 200, displayed on the computing device 104 associated with the food service provider.

Referring to FIG. 3, illustrated is a schematic illustration the computing device 106, of the system 100 of FIG. 1, associated with the consumer having an exemplary user interface 300, in accordance with an embodiment of the present disclosure. As shown, FIG. 3 includes input fields (such as the input fields 302 to 308) for acquiring consumer information from the consumer. Furthermore, the exemplary user interface 300 is configured to provide the data processing arrangement 102 with consumer information acquired from the consumer, via the communication network 108.

The data processing arrangement 102 is configured to receive consumer information including at least one of: food habit, food preferences, nutritional requirements, medical conditions, use of medications, general physical condition, age, allergies and undesirable food ingredients, to be provided by the consumers using the computing devices 106 associated with the consumers.

Optionally, the term ‘consumer’ as used herein relate to individuals and/or users accessing the exemplary user interface 300, provided in the computing device 106. Furthermore, the consumers access the exemplary user interface 300 for retrieving a digital food plan associated with a food service provider (such as the digital food plan and the food service provider described herein above in FIG. 2). Additionally, the consumers input their consumer information in the input fields 302 to 306, of the exemplary user interface 300 to retrieve such digital food plan.

Optionally, the term ‘consumer information’ as used herein relate to a preference of quality, quantity, and accessibility of a food item to be consumed by the consumer. Furthermore, the consumer information of the consumer includes information related to undesirable ingredients, including allergens, that the consumer prefers to avoid or has to avoid because of suffering from certain health conditions. Additionally, the consumer information also includes preferred nutritional value for the consumer and/or food preferences of the consumer.

Optionally, the input fields 302 to 306 displayed in the exemplary user interface 300 are configured to accept the consumer information inputted by the consumer. In an example, a consumer ‘C1’ may use input field such as the input field 302 in the exemplary user interface 300, displayed on the computing device 106 for selecting the undesirable food ingredients that the consumer ‘C1’ prefers to avoid. In such example, input field 302 may include ingredients ‘I1’, ‘I2’, and ‘I3’. Furthermore, in such example, the consumer ‘C1’ may select the ingredients ‘I1’ and ‘I2’ to be excluded. In another example, the consumer ‘C1’ may use input field such as the input field 304 in the exemplary user interface 300 for selecting the amount and/or nutritional value. In such example, input field 304 may include nutritional elements, such as ‘NE1’, ‘NE2’, ‘NE3’, ‘NE4’, and ‘NE5’. Furthermore, in such example, the consumer ‘C1’ may select the value of the nutritional elements ‘NE1’, ‘NE2’, ‘NE3’, ‘NE4’, and ‘NE5’. In another example, the consumer ‘C1’ may use input field such as the input field 306 in the exemplary user interface 300 for inputting the food preferences. In such example, the input field 306 may include a header for selecting the amount of cost of a food item, a header for selecting a preferred range of geographical distance of the food service provider from the location of a consumer. Furthermore, in such example, the consumer ‘C1’ may select the amount of cost of a food item to be ‘100 dollars’ and the preferred range of geographical distance to be ‘5 km’. In another example, the exemplary user interface 300 may include selection button, such as the button 308. In such example, the service provider may select the button 308 to find a food item based on the selected preferences such the aforementioned preferences of ingredients, nutritional value and personal preferences.

The exemplary user interface 300 may include input fields (not shown) for acquiring consumer information related to food habit, medical conditions, general physical condition, age, allergies and use of medications. Optionally the term ‘food habit’ as used herein relate to a type of food the consumer consumes. In an example, the consumer ‘C1’ may have a food habit of consuming non-vegetarian food. Further, the term ‘medical conditions’ as used herein relate to a type of illness or abnormality of the consumer. For example, the consumer ‘C1’ may have ‘diabetes’. The term “general physical condition” as used herein relate to physical health of the consumer, such as a body mass index, i.e. a ratio of consumer's weight (in kilograms) by square of consumer's height (in meters). The “general physical condition” can be further correlated with the age of the consumer. Moreover, term “allergies” as used herein relate to details of certain substances (particularly edible ingredients) that can cause highly sensitive reaction to the consumer's body. Therefore, the allergies (i.e. the information provided by the consumer) associated with a consumer essentially correlate to the allergens used in preparation of a food item (i.e. the information provided by the food service provider). Furthermore, the term ‘use of medications’ as used herein relates to drugs or other form of medicines for the medical conditions of the consumer. For example, the consumer ‘C1’ may have to consume ‘Novolin’ and ‘Humulin’ for the medical condition ‘diabetes’.

The data processing arrangement 102 is configured to filter digital food plans, based on the consumer information, to provide desirable food items to the consumers. Specifically, the data processing arrangement 102 to identify the desirable food items in a digital food plan, for the consumer. Furthermore, the desirable food items are food item which does not contain the ingredients to be avoided by the consumer. Thereby providing the consumer with a food item based on the consumer information. Optionally the term ‘filter’ as used herein relate to selection of food items that do not contain the ingredients to be avoided by the consumer. Specifically, the data processing arrangement 102 is configured to identify the food item in the digital food plan of a food service provider, that comply with the food habit, food preferences, nutritional requirements, medical conditions, use of medications, general physical condition, age, allergies and undesirable food ingredients, of the consumer. Optionally, the data processing arrangement 102 is operable to identify the undesirable food ingredients that the consumer wants to avoid based on the consumer information provided by the consumer using the exemplary user interface 300 of the computing device 106.

Additionally, the data processing arrangement 102 is configured to analyze the food information related to the food item of a digital food plan, to identify ingredients used in the recipe of the food item and provide desirable food items to the consumers. Furthermore, in an event wherein an ingredient used in a recipe of a food item matches an undesirable food ingredient that has been selected by the consumer to be avoided or is recommended to be avoided, the data processing arrangement 102 discards the food item, and thereafter analyzes food information related to another food item of the digital food plan. Additionally, the data processing arrangement 102 may suggest the food service provider to offers the desirable food item to the consumers. In an example, a food item ‘FI1’ of a digital food plan of the food service provider ‘XYZ’ may contain undesirable food ingredients ‘A1’ and ‘A2’ and a food item ‘FI2’ of a digital food plan of the food service provider ‘XYZ’ may contain ingredient ‘A3’ and ‘A4’. Furthermore, in such example, if a consumer ‘C1’ select the ingredients ‘A1’ and ‘A2’ to be undesirable food ingredient. The data processing arrangement 102 is configured to identify the food item ‘FI2’ to be a desirable food item to the consumers, and thereafter instruct the food service provider ‘XYZ’ to provide the consumer ‘C1’ with the food item ‘FI2’ of the digital food plan of the food service provider ‘XYZ’.

Optionally, the data processing arrangement 102 is operable to suggest the food service providers, alterations for the at least one of the ingredients and/or the cooking procedure associated with a food item, to provide a tailored food item for a consumer based on a consumer information of the consumer. Additionally, the data processing arrangement 102 may suggest the food service provider to offer the tailored food items to the consumers. In an example, a food item ‘FI3’ of a digital food plan of the food service provider ‘XYZ’ may contain ingredient ‘A1’ ‘A2’ and ‘A3’. Furthermore, if a consumer ‘C2’ select the ingredients ‘A1’ to be an undesirable food ingredient, then in such event the data processing arrangement 102 is operable to suggest the food service providers ‘XYZ’ to discard the use of the ingredients ‘A1’ for the food item ‘FI3’. Thereby suggesting the food service providers ‘XYZ’ to alter the food item ‘FI3’ to contain the ingredients ‘A2’ and ‘A3’.

Optionally, the data processing arrangement 102 is configured to filter the digital food plan based on the preferred nutritional requirements for the consumer. Specifically, the data processing arrangement 102 analyzes the nutritional value associated with a food item of the digital food plan based on the preferred nutritional requirements for the consumer. Furthermore, if the nutritional value associated with a food item matches the preferred nutritional requirements for the consumer, the data processing arrangement 102 provides the consumer with the name of the food item.

Optionally, the data processing arrangement 102 is configured to filter the digital food plan based on the food preferences of the consumer. In an example, a customer ‘C1’ may opt to locate food service providers that are located within a 5 km distance from the location of the customer ‘C1’, and offers a food item within the cost of ‘100 dollars’. In such example, the data processing arrangement 102 is configured to analyze the food information of the food items provided by the food service provider. Furthermore, the data processing arrangement 102 is configured to identify the food service provider located within 5 km distance from the location of the customer ‘C1’, and offers a food item within the cost of ‘100 dollars’. Thereafter, provide the consumer ‘C1’ with the name of the food service provider and a food item provided by the food service provider.

Optionally, the data processing arrangement 102 is configured to filter the digital food plan based on the medical conditions of the consumer. Specifically, the data processing arrangement 102 is operable to match the consumer information such the food habit, medical conditions and use of medications to filter the digital food plan. In an example, a consumer ‘C1’ may have a food habit of consuming non-vegetarian, further the consumer ‘C1’ may be diabetic and may use diabetic medication. In such example, the data processing arrangement 102 is configured to filter a digital food plan provided by a food service provider ‘XYZ’ to identify at least one food item that contains ingredients which are not to be avoided by the consumer ‘C1’.

In another example, a consumer ‘C1’ may be using the medication ‘Zyloprim’ for a medical condition ‘Hyperuricemia’. In such example, the data processing arrangement 102 may be operable to identify the food ingredients such as an ingredient ‘red meat’, that may be harmful for the consumer while consuming of the medication ‘Zyloprim’. In such example, the data processing arrangement 102 may identify a food item including the ingredient ‘red meat’ to be an undesirable food item. Therefore, the data processing arrangement 102 may filter a digital plan to exclude the food item including the ingredient ‘red meat’.

In another example, a consumer ‘C1’ may use the exemplary user interface 300 to provide the data processing arrangement 102 with medical information, such as, consumption of a medicine ‘Cozaar’ for a medical condition ‘high blood pressure’. In such example, the data processing arrangement 102 may identify that ‘alcoholic beverages’ are harmful for the consumer ‘C1’, while the consumer ‘C1’ is using the medication ‘Cozaar’. Therefore in such example, the data processing arrangement 102 may exclude a food item including ‘alcoholic beverages’ as an ingredient, while filtering the digital plan including the food item.

Optionally, the data processing arrangement 102 is operable to analyze the acquired data associated with the offered food items to determine one of: a consumption history of the consumers, a food consumption trend of the consumers, an impact of food consumption on the consumers' health, a geographical area associated specific food items.

Optionally, the data processing arrangement 102 is operable to store information related to the food items of a digital food plan provided by a food service provider, which is consumed by the consumer. For example, data processing arrangement 102 stores the number of times a consumer ‘C1’ selects a food item ‘F1’ from a food service provider ‘XYZ’ and a food item ‘F2’ from a food service provider ‘ABC’. In such the data processing arrangement 102 generates a consumption history of the consumer ‘C1’ identifying the number of times a food item has been selected by the consumer ‘C1’.

Optionally, the data processing arrangement 102 is operable to analyze the consumption history of the consumers to generate food consumption trend of the consumers. For example, in an event, a consumer ‘C1’ selects a food item ‘F1’ from a food service provider ‘XYZ’ more often than a food item ‘F2’ from a food service provider ‘ABC’. In such example, the data processing arrangement 102 is operable to generate a food consumption trend for the consumer ‘C1’ identifying that the consumer ‘C1’ has an affinity of selecting the food item ‘F1’ when offered a choice between the food item ‘F1’ and ‘F2’.

Optionally, the data processing arrangement 102 is operable to identify the impact of food consumption on the consumers' health based on the food consumption trend of the consumer. For example, a consumer ‘C1’ may be a diabetic and has a food consumption trend of consuming food item which contains a high amount of carbohydrate. In such event, the data processing arrangement 102 may identify that the impact of food consumption on the consumers' health to be risky.

Optionally, the data processing arrangement 102 is operable to identify geographical area associated specific food items. In an example, a consumer ‘C1’ may have a trend of selecting the food item ‘F1’ provided by a food service provider ‘XYZ’. In such example, the food service provider ‘XYZ’ may be located in a place ‘MN’. In such example, data processing arrangement 102 is operable to store the location of the food service provider ‘XYZ’ which provides the food item ‘F1’ preferred by the consumer ‘C1’. Furthermore, the data processing arrangement 102 is operable to calculate the distance of food service provider ‘XYZ’ from the location of the consumer ‘C1’, such as 10 km.

Optionally, the data processing arrangement 102 may be operable to communicate with external resources to acquire information related to the consumer. Specifically, the data processing arrangement 102 may communicate with medical databases, to acquire medical information related to the consumer. More specifically, the medical information related to the consumer may contain any medical condition associated to the consumer, medical test results and/or the medication prescribed (or medical recommendations) to the consumer for the medical condition. Furthermore, the data processing arrangement 102 may use such information to filter the digital menu to exclude food item that may be harmful for the consumer.

Optionally, the data processing arrangement 102 is operable to suggest the consumer with the suggestion of food item. Furthermore, the data processing arrangement is operable to suggest desirable food items to the consumers based on the consumption history, the food consumption trend, impact of food consumption and the geographical areas. Optionally, a consumer is operable to rate a food service provider based on the quality of the service provided by the food service provider. Furthermore, the data processing arrangement 102 is operable to suggest food items based on a rating to the consumer based on a selection history of the consumer

Optionally, the data processing arrangement 102 is operable to match the quantity of food used in the preparation of a food item and the amount of selection received for the food item. Furthermore, the data processing arrangement 102 is operable to calculate the amount of wastage associated with the food item. In an example, 10 kilograms of indignant are used for the preparation of the food item ‘F4’. In such example, the food item ‘F4’ may be selected by one consumer for one serving. In such example, the data processing arrangement 102 is operable to identify a wastage for the food item ‘F4’.

In one embodiment, the present disclosure provides a system (not shown) for managing digital food information, the system includes at least one device associated with a food service provider (such as the computing devices 104, 106). The at least one device includes a data processing arrangement (such as data processing arrangement 102). The data processing arrangement is operable to: generate a digital food plan, by the food service provider using the computing device associated therewith, comprising at least one food item, wherein the at least one food item is defined with food information including at least one of ingredients and cooking procedure associated with the at least one food item; receive consumer information including at least one of: food habit, food preferences, nutritional requirements, medical conditions, use of medications, general physical condition, age, allergies and undesirable food ingredients; and filter digital food plans, based on the consumer information, to provide desirable food items to consumers.

In accordance with the above embodiment, the data processing arrangement may be associated with a food service provider, such as the hospital, the domiciliary care or the care home. Further, the data processing arrangement may communicate with (or operatively coupled to) a database to acquire consumer information related to the consumer. In an example, the database, may include one of a database of a hospital, a database of a domiciliary care, or a database of a care home, having the consumer information of consumer stored therein. In an embodiment, the database may be operable to include updated consumer information related to the consumer. It is to be understood that, the data processing arrangement and the database may be implemented using at least one computing device, such as one computing device having both the data processing arrangement and the database therein, or two separate computing devices associated with the data processing arrangement and the database individually. Therefore, the consumer information may not be provided by the consumer to the data processing arrangement rather such consumer information is retrieved by the data processing arrangement automatically from the database. As mentioned herein above, the consumer information includes at least one of: food habit, food preferences, nutritional requirements, medical conditions, use of medications, general physical condition, age, allergies and undesirable food ingredients. However, in the present embodiment the consumer information primarily includes medical information associated with a consumer. In an example, the medical information may include any medical condition associated to the consumer, medical test results and/or the medication prescribed (or medical recommendations) to the consumer for the medical condition. Accordingly, the data processing arrangement of the present embodiment may use such medical information to filter the digital plan to exclude food item that may be harmful for the consumer. This allows a hospital, a domiciliary care or a care home to efficiently identify and provide desirable food items to the consumers associated therewith.

Referring to FIG. 4, illustrated are steps of a method 400 of managing digital food information, in accordance with an embodiment of the present disclosure. At a step 402, a digital food plan is generated, by each of the plurality of food service providers using the computing devices associated therewith, that comprises at least one food item, wherein the at least one food item is defined with food information including at least one of ingredients and cooking procedure associated with the at least one food item. At a step 404, consumer information including at least one of: food habit, food preferences, nutritional requirements, medical conditions, use of medications, general physical condition, age, allergies and undesirable food ingredients, to be provided by consumers is received. At a step 406, digital food plan is filtered, based on the based on the consumer information, to provide desirable food items to the consumers.

The steps 402 to 406 are only illustrative and other alternatives can also be provided where one or more steps are added, one or more steps are removed, or one or more steps are provided in a different sequence without departing from the scope of the claims herein.

In an embodiment, the present disclosure provides a software product recorded on machine-readable data storage media, characterized in that the software product is executable upon computing hardware for implementing the aforementioned described method 400 of managing digital food information. Such a software produced is relevant to operation of a system for managing digital food information as described in the foregoing.

The present disclosure provides an efficient system for managing digital food information. The present system enables a food service provider to describe a food item adequately. Furthermore, the system is operable to enable a consumer to locate a food item that is suitable for the consumer. Moreover, a consumer may implement the system to select food item based on the allergens and ingredients used in a food item. Therefore, a consumer having health issues, such as food allergies towards few specific ingredients, may be self-assured that the consumer is having an allergen free food item. Additionally, the food service provider may be operable to update and/or edit the food information related to a food item. Therefore, a consumer may have access to any change or alteration in the food item. Furthermore, a consumer may use the present system to select a food item that has the exact amount of nutritional value that the consumer intends to consume.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A system for managing digital food information, the system includes a data processing arrangement, a plurality of computing devices associated with food service providers, a plurality of computing devices associated with consumers, wherein the data processing arrangement is coupled via a communication network to the computing devices of the food service providers and the consumers, characterized in that the data processing arrangement is operable to:
generate a digital food plan, by each of the plurality of food service providers using the computing devices associated therewith, comprising at least one food item, wherein the at least one food item is defined with food information including at least one of ingredients and cooking procedure associated with the at least one food item;
receive consumer information including at least one of: food habit, food preferences, nutritional requirements, medical conditions, use of medications, general physical condition, age, allergies and undesirable food ingredients, to be provided by the consumers using the computing devices associated with the consumers; and
filter digital food plans, based on the consumer information, to provide desirable food items to the consumers.

2. A system according to the claim 1, wherein that the data processing arrangement is operable to suggest the food service providers, alterations for the at least one of the ingredients and/or the cooking procedure associated with a food item, to provide a tailored food item for a consumer based on a consumer information of the consumer.

3. The system according to claim 1, wherein that the food service providers offers the desirable food and the tailored food items to the consumers.

4. The system according to claim 3, wherein that the data processing arrangement is operable to acquire data associated with the food items offered by the service providers to the consumers.

5. The system according to claim 4, wherein that the data processing arrangement is operable to analyze the acquired data associated with the offered food items to determine one of:
a consumption history of the consumers,
a food consumption trend of the consumers,
an impact of food consumption on the consumers health, and
a geographical areas associated specific food items.

6. The system according to claim 5, wherein that the data processing arrangement is operable to suggest desirable food items to the consumers based on the consumption history, the food consumption trend, impact of food consumption and the geographical areas

7. The system according to claim 1, wherein that the food information further includes food quantity associated with the at least one food item.

8. A method of managing digital food information, wherein that the method includes:
generating digital food plans comprising at least one food item, wherein the at least one food item is defined with food information including at least one of ingredients and cooking procedure associated with the at least one food item provided by food service providers;
receiving consumer information including at least one of: food habit, food preferences, nutritional requirements, medical conditions, use of medications, general physical condition, age, allergies and undesirable food ingredients, to be provided by consumers; and
filtering the digital food plans, based on the consumer information, to provide desirable food items to the consumers.

9. A computer program product comprising a non-transitory computer-readable storage medium having computer-readable instructions stored thereon, the computer-readable instructions being executable by a computerized device comprising processing hardware to execute a method of claim 8.

10. A system for managing digital food information, the system includes at least one device associated with a food service provider, the at least one device includes a data processing arrangement, characterized in that the data processing arrangement is operable to:
generate a digital food plan, by the food service provider using the computing device associated therewith, comprising at least one food item, wherein the at least one food item is defined with food information including at least one of ingredients and cooking procedure associated with the at least one food item;
receive consumer information including at least one of: food habit, food preferences, nutritional requirements, medical conditions, use of medications, general physical condition, age, allergies and undesirable food ingredients; and
filter digital food plans, based on the consumer information, to provide desirable food items to consumers.
